(19) United States
(12) Patent Application Publication
(10) Pub. No.: US 2004/0004363 A1
(43) Pub. Date: Jan. 8, 2004

(54) Shark tooth retrieval tool

(76) Inventor: Joseph R. Drewery, Oliver Springs, TN (US)

Correspondence Address: MICHAEL E. McKEE, Attorney at Law, 804 Swaps Lane, Knoxville, TN, 37923, US

(21) Appl. No.: 10/190,250

(22) Filed: Jul. 5, 2002

(51) Int. Cl. B25J 1/04

(52) U.S. Cl. 294/19.1; 294/55

(57) ABSTRACT

A retrieval tool for retrieving a shark tooth from the surface of sand of a beach utilizes an elongated handle and a receptacle arranged adjacent one end of the handle with which a shark tooth can be scooped from the sand with the tool. The tool also includes a spacer member which joins the receptacle and handle so that the receptacle is held to one side of and is spaced from the one end of the handle to enhance the viewability of the receptacle as the receptacle is moved in a scooping motion through the sand to collect the shark tooth with the tool.

### BACKGROUND OF THE INVENTION

This invention relates generally to retrieval tools for picking items up from ground level and relates, more particularly, to the means and methods for picking up salvageable items, namely shark teeth, from the sand of a beach.

Apparatus are known which can be used for retrieving salvageable items from the sand of a beach. Examples of such apparatus include sifting implements such as are shown and described in U.S. Pat. Nos. 4,979,623 and 5,248,153. However, the sifting implements of these referenced patents are designed to sift through a quantity of sand (e.g. beach sand) in a search for items which are hidden from view (i.e. not viewable upon the surface of the sand). Thus, it is not important for the functioning of these implements that items which are scooped into the implements with a quantity of sand be seen before they are scooped into the implements.

It is an object of the present invention to provide a new and improved retrieval tool for retrieving salvageable items, namely shark teeth, from the sand of a beach.

Another object of the present invention is to provide such a tool which is particularly well-suited for retrieving salvageable items, namely shark teeth, which can at least be partially seen upon the surface of the sand of a beach.

Still another object of the present invention is to provide such a tool which is particularly well-suited for retrieving shark teeth which are relatively small in size from the sand of a beach.

Yet another object of the present invention is to provide such a tool which is uncomplicated in construction yet effective in operation.

One more object of the present invention is to provide a kit for retrieving and collecting shark teeth from the sand of a beach.

### SUMMARY OF THE INVENTION

This invention resides in a retrieval tool for retrieving a shark tooth from the surface of sand.

The tool includes an elongated handle having two opposite ends, one end of which is adapted to be held by the user for use of the tool, and a receptacle arranged adjacent the end of the handle opposite the one end with which a shark tooth can be scooped with the tool while the user holds the one end of the handle. The receptacle includes a portion provided with a plurality of through-openings through which sand is permitted to pass as the receptacle is moved through the sand in a scooping motion, and the tool further includes means for joining the receptacle to the handle so that the receptacle is held to one side of and is spaced from the end of the handle opposite the one end to enhance the viewability of the receptacle as the receptacle is moved through the sand during a scooping motion to retrieve the shark tooth from the surface of the sand.

### BRIEF DESCRIPTION OF THE DRAWINGS

FIG. 1 is a perspective view of an embodiment of a retrieval tool within which features of the present invention are utilized.

FIG. 2 is a side elevational view of a fragment of the FIG. 1 tool.

FIG. 3 is a perspective view illustrating the tool of FIG. 1 being used to pick up a shark tooth from the sand of a beach.

FIG. 4 is a perspective view of a fragment of the FIG. 1 tool as the fragment is guided through the sand of a beach in a scooping motion.

FIG. 5 is a view similar to that of FIG. 2 of an alternative embodiment of a retrieval tool.

FIGS. 6 and 7 are perspective views of another alternative embodiment of a retrieval tool.

FIG. 8 is a perspective view of a container within which shark teeth which are collected from the beach with a retrieval tool can be contained.

FIG. 9 is a perspective view of the FIG. 8 container, shown exploded.

### DETAILED DESCRIPTION OF THE ILLUSTRATED EMBODIMENTS

Turning now to the drawings in greater detail, there is shown in FIG. 1 an embodiment, generally indicated 20, of a retrieval tool within which features of the present invention are incorporated and which is designed to facilitate the picking up of salvageable items, namely shark teeth, from the surface of sand. The items (i.e. shark teeth) capable of being picked up with the tool 20 are normally small in size, and the sand from which the shark teeth are collected is of a type commonly found on a sand-covered beach.

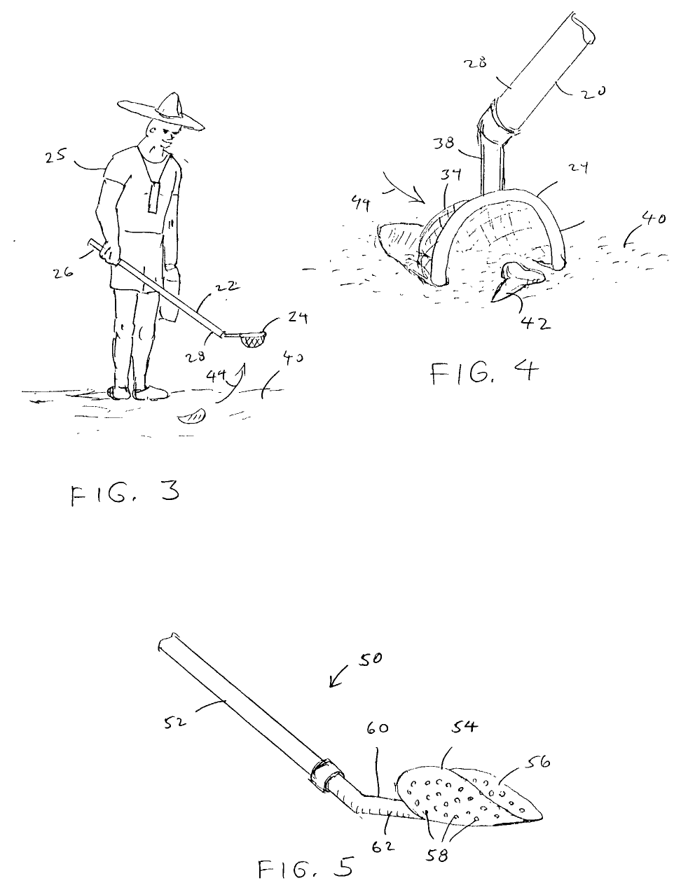

With reference still to FIG. 1, the tool 20 includes an elongated handle 22 and an open-mouthed receptacle 24 joined to the handle 22 at one end thereof. To use the tool 20 to pick up a shark tooth from the sand, the handle 22 of the tool 20 is held by a user 25 (FIG. 3), and the open-mouthed receptacle 24 is directed through the sand in a scooping motion to scoop the shark tooth from the sand and into the receptacle 24.

As best shown in FIG. 1, the handle 22 includes two opposite ends 26 and 28 and is relatively straight along its length. One end 26 is adapted to be grasped by the hand of a user 25 (FIG. 3) for use of the tool 20 and can be considered to be the proximal end of the tool 20 in that the end 26 is the end of the handle 22 closest to the user 25 during use. Meanwhile, the end 28 is the end of the handle 22 opposite the end 26 and can be considered as the distal end of the handle 22. The handle 22 can be constructed of a relatively hard plastic, but other materials, such as wood, can be used.

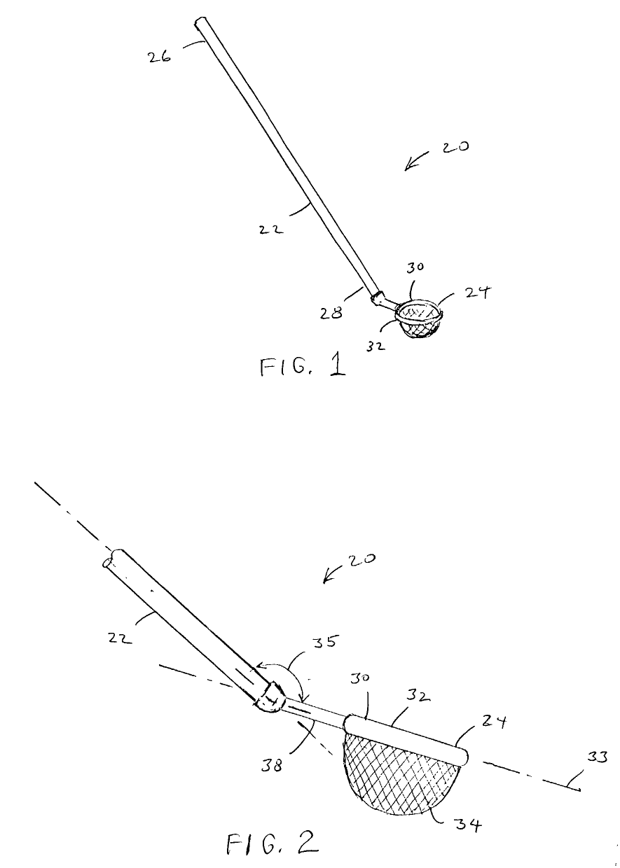

With reference to FIGS. 1 and 2, the open-mouthed receptacle 24 includes a mouth 30 bounded by a circular ring, or rim 32, arranged in a plane 33 (FIG. 2) and further includes a basket portion 34 which is joined to the rim 32. The basket portion 34 is forminous in nature in that it includes several through-openings 36 defined along its sides and bottom. As the tool 20 is used to scoop a shark tooth from the sand with the open-mouthed receptacle 24, the rim 32 acts as a leading edge which is guided through the sand situated beneath the shark tooth in a scooping motion, and for this reason is rigid enough to resist deformation during the scooping motion. Meanwhile, the openings 36 provided in the sides and bottom of the basket portion 34 permit sand to pass, or sift, through the sides and bottom of the basket portion 34 as the basket portion 34 follows the rim 32 leaving the desired shark tooth within the basket portion 34. It follows that the openings 36 provided in the sides and bottom of the basket portion 34 are smaller than the shark tooth desired to be picked up with the open-mouthed receptacle 24. The material out of which the rim 32 and basket portion 34 of the depicted tool 20 is constructed is metal (e.g. steel) wherein the basket portion 24 is formed out of a wire screen material, but other materials, such as a plastic screen material can be used.

It is a feature of the tool 20 that the open-mouthed receptacle 24 is disposed to one side of the handle 22 and opens angularly away from the one handle side. More particularly and with reference to FIG. 2, the open-mouthed receptacle 24 is arranged to one side of the handle 24 so that the plane 33 (within which the rim 32 of the receptacle 24 is lies) forms an obtuse angle 35 with the longitudinal axis, indicated 36, of the handle 22 within the range of between 140 degrees and 170 degrees. For most favorable results with the tool 20, the angle 35 is preferably about 155 degrees.

For joining the open-mouthed receptacle 24 to the handle 22 and for maintaining the receptacle 24 in a spaced relationship with and to one side of the handle 22, the tool 20 includes a spacer, indicated 38 in FIG. 2. In the depicted tool 20, the spacer 38 is provided by a relatively short shaft which extends between the handle end 28 and one side of the rim 32. The spacer 38 has a length in the range of between 0.5 and 4.0 inches, and is preferably about one inch in length. The spacer 38 can be comprised of metal or plastic and, if desired, can be integrally formed (e.g. molded) with the open-mouthed receptacle 24 or with the handle 22. As will be apparent herein, an advantage provided by the spacer 38 relates to the fact that the receptacle 24 is readily viewable during use of the tool 20.

To use the tool 20 and with reference to FIGS. 3 and 4, the handle 22 is grasped by the user 25 adjacent the end 26 of the handle 22, and the open-mouthed receptacle 24 is used as a scoop to pick up a shark tooth, indicated 42, from the sand, indicated 40. More specifically, the open-mouthed receptacle 24 is moved in a scooping motion (e.g. along an arcuate path and in the direction indicated with the arrow 44) so that one side edge (or the lower side edge as viewed in FIG. 4) of the rim 32 is guided through the region of sand 40 which lay directly beneath the shark tooth 42 to be picked up with the receptacle 24. This way, the basket portion 34 (which follows the rim 32 through the sand) captures the shark tooth 42 to be picked up while the (unwanted) particles of sand are permitted to pass through the openings 36 provided in the sides and bottom of the basket portion 34.

As mentioned earlier, an advantage provided by the spacer 36 is that it enhances the viewability of the receptacle 24 during use of the tool 20. More particularly, since the receptacle 24 is held to one side of the handle 22 by way of the spacer 38, the receptacle 24 is in a position to be easily watched by the user as he guides the receptacle 24 through its swooping motion to scoop, or capture, the shark tooth within the receptacle 24. Since a shark tooth to be picked up with the tool 24 will normally be at least partially viewable atop the surface of the sand, the user can watch both the receptacle 24 and the shark tooth being scooped therein as the receptacle 24 is visually guided toward the tooth to be retrieved from the sand. This advantage can be readily appreciated when comparing the viewability of the receptacle 24 of the depicted tool 20 with the receptacle of an alternative tool wherein the receptacle is arranged in-line with, rather than offset to, an elongated handle. When scooping up an item from the sand with such an alternative tool, the handle of the alternative tool is likely to obstruct the view of the item being scooped up with the receptacle thereof.

Another advantage provided by the tool 20 relates to the rim 32 and its size in relationship with respect to the basket portion 34. More specifically, the inner diameter of the rim 32 is slightly smaller than the (inner) diameter of the basket portion 34 as measured across the mouth thereof (i.e. adjacent the rim 32). Therefore, once a shark tooth has been scooped up with the receptacle 24 (so as to move past the rim 32), the rim 32 prevents the captured tooth from falling back out of the receptacle through the rim 32 thereof. This size relationship between the diameters of the rim 32 and basket portion 34 adjacent the rim 32 helps to retain the scooped-up shark tooth within the receptacle 24, and thus provides an advantage in this respect.

Exemplary dimensions of the tool 20 are provided here as follows: The handle 22 has a length of between 2.5 and 4 feet; the spacer 38 is about 1 inch in length; and the diameter of the rim 32 is about 3 inches.

With reference to FIG. 5, there is shown an alternative tool, generally indicated 50, embodying features of the present invention. The tool 50 includes a handle 52 and a receptacle 54 which is joined to the handle 52 at one end thereof and which is supported to one side of and spaced from the handle 52. In the depicted tool 50, the receptacle 54 is in the form of a spade 56 having a series of through-openings 58 defined therein. As is the case with the tool 20 of FIGS. 1-4 and with reference to FIG. 6, the receptacle 54 of the tool 50 opens angularly away from the side of the handle 52 to which it is disposed.

Moreover, the tool 50 includes a spacer 60 which joins the receptacle 54 to the handle 52 at one end, or the distal end, thereof. In the tool 50, the spacer 60 is in the form of a short, straight shaft 62 which extends between the handle 52 and the receptacle 54. Furthermore, the shaft 62 is substantially aligned with the bottom of the receptacle 54 and supports the receptacle 54 at such an angle to the handle 52 so that the bottom of the receptacle 54 and the spacer 60 form an angle of about 155 degrees.

It follows from the foregoing that a tool has been shown and described herein which includes a handle, a receptacle for scooping a salvageable shark tooth from sand of a beach, and joining means in the form of a spacer which supports and maintains the receptacle in a spaced and angular relationship to one side of the handle and to enhance the viewability of the receptacle as the receptacle is moved through the sand in a scooping motion to retrieve the shark tooth.

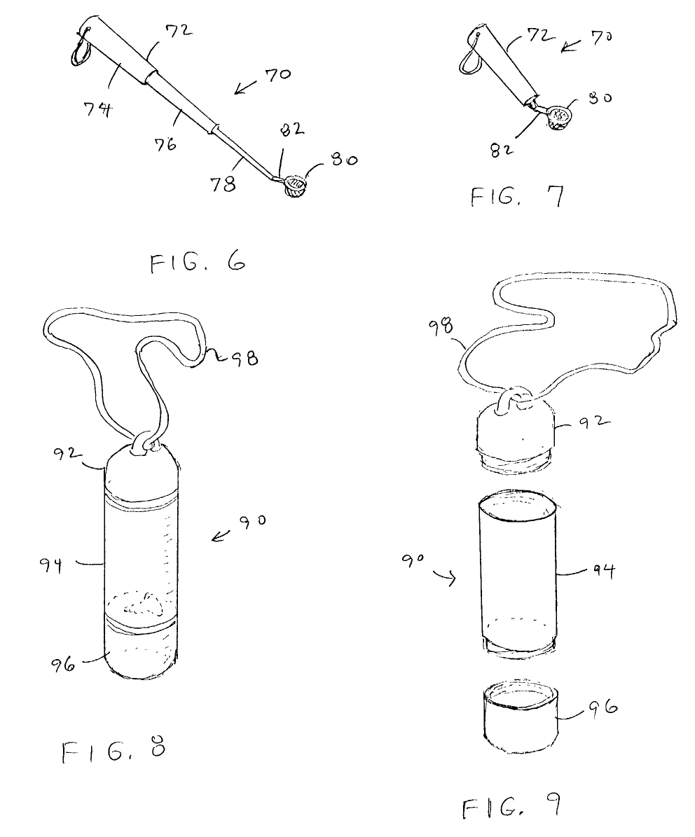

It will be understood that numerous modifications and substitutions can be had with the aforedescribed embodiments without departing from the spirit of the invention. For example, although the aforedescribed retriever tool embodiments have been shown and described as having handles of fixed length, an embodiment of a retriever tool can have a handle whose length can be altered. For example, there is illustrated in FIGS. 6 and 7 an embodiment, generally indicated 70, of a retriever tool having a handle 72 of adjustable length and a receptacle 80 joined to one end of the handle by way of a spacer 82. The handle 72 includes telescoping sections 74, 76 and 78 which can be moved between an extended condition as illustrated in FIG. 6 and a collapsed condition as illustrated in FIG. 7.

Furthermore, a container can be combined with the retriever tool of the invention to provide a kit for collecting and retrieving salvageable shark teeth from the sand of a beach. For example, there is illustrated in FIGS. 8 and 9 a container 90 having multi-level compartments within which retrieved shark teeth can be collected. In particular, the container 90 includes a screw-on cap 92, a middle collection compartment 94 and a screw-on bottom compartment 96. While the middle collection compartment 94 provides a relatively deep compartment within which shark teeth can be collected and stored, the bottom compartment 96 can be used to hold coins or other forms of money. A strap 98 is attached to the cap 92 to enable the container 90 to be suspended from the user's neck. It has been found that the depicted container 90 and retriever tool 20 provide a convenient kit with which shark teeth found on a beach can be collected and retrieved.

Accordingly, the aforedescribed embodiments are intended for the purpose of limitation and not as limitation.

1. A retrieval tool for retrieving a shark tooth from the surface of sand at a beach, the tool comprising:
an elongated handle having two opposite ends, one end of which is adapted to be held by the user for use of the tool;
a receptacle arranged adjacent the end of the handle opposite the one end with which a shark tooth can be scooped with the tool from the surface of sand at a beach while the user holds the one end of the handle, the receptacle including a portion provided with a plurality of through-openings through which sand is permitted to pass as the receptacle is moved through the sand in a scooping motion; and
means for joining the receptacle and the end of the handle opposite the one end so that the receptacle is held to one side of and is spaced from the end of the handle opposite the one end to enhance the viewability of the receptacle as it is moved through the sand in a scooping motion to retrieve the shark tooth from the surface of the sand with the tool.

2. The tool as defined in claim 1 wherein the means for joining spaces the receptacle to one side of the handle by a distance of between 0.5 and 4.0 inches.

3. The tool as defined in claim 2 wherein the means for joining spaces the receptacle to one side of the handle by a distance of about one inch.

4. The tool as defined in claim 1 wherein the handle has a longitudinal axis and the receptacle has a mouth which opens in an angular relationship with respect to the longitudinal axis of the handle, and the receptacle mouth and the longitudinal axis of the handle form an angle within the range of between about 140 degrees and 170 degrees.

5. The tool as defined in claim 4 wherein the receptacle mouth and the longitudinal axis of the handle form an angle of about 155 degrees.

6. The tool as defined in claim 1 wherein the receptacle has an open mouth which is substantially circular, and the diameter of the receptacle mouth is about three inches.

7. The tool as defined in claim 1 wherein the portion of the receptacle provided with a plurality of through-openings is cup-shaped and includes a screen material.

8. The tool as defined in claim 1 wherein the handle has a length which is within the range of between about 2.5 and 4 feet.

9. The tool as defined in claim 1 wherein the handle includes telescoping sections enabling the length of the handle to be adjusted.

10. A retriever tool for retrieving a shark tooth which is at least partially viewable atop the sand of a beach, the tool comprising:
an elongated handle having a longitudinal axis and two opposite ends, one end of which is adapted to be held by the hand of a user for use of the tool;
a receptacle arranged adjacent the end of the tool opposite the one end with which a shark tooth can be scooped from the sand; and
means for joining the receptacle to the handle and maintaining the receptacle in a spaced condition to one side of the handle opposite the one end so that the receptacle opens away from and at an angle with respect to the longitudinal axis of the handle.

11. The tool as defined in claim 10 wherein the means for joining spaces the receptacle to one side of the handle by a distance of between 0.5 and 4.0 inches.

12. The tool as defined in claim 11 wherein the means for joining spaces the receptacle to one side of the handle by a distance of about one inch.

13. The tool as defined in claim 10 wherein the handle has a longitudinal axis and the receptacle has a mouth which opens in an angular relationship with respect to the longitudinal axis of the handle, and the receptacle mouth and the longitudinal axis of the handle form an angle within the range of between about 140 degrees and 170 degrees.

14. The tool as defined in claim 13 wherein the receptacle mouth and the longitudinal axis of the handle form an angle of about 155 degrees.

15. The tool as defined in claim 10 wherein the receptacle has an open mouth which is substantially circular, and the diameter of the receptacle mouth is about three inches.

16. The tool as defined in claim 10 wherein the receptacle includes a cup-shaped portion which is provided with a plurality of through-openings through which sand is permitted to pass as the receptacle is moved through the sand in a scooping motion.

17. The tool as defined in claim 10 wherein the handle has a length which is within the range of between about 2.5 and 4 feet.

18. The tool as defined in claim 17 wherein the handle includes telescoping sections enabling the length of the handle to be adjusted.

19. The tool as defined in claim 10 wherein the receptacle has a circular open mouth, a rim which borders the open mouth, a cup-shaped basket portion joined to the rim, and the rim has an inner diameter which is slightly smaller than the diameter of the basket portion adjacent the rim to facilitate the retention of the shark tooth within the receptacle after the shark tooth has been scooped into the receptacle.

20. A shark tooth retrieval and collection kit comprising:
a retrieval tool including
a) an elongated handle having two opposite ends, one end of which is adapted to be held by the user for use of the tool;
b) a receptacle arranged adjacent the end of the handle opposite the one end with which a shark tooth can be scooped with the tool while the user holds the one end of the handle, the receptacle including a portion provided with a plurality of through-openings through which sand is permitted to pass as the receptacle is moved through the sand in a scooping motion; and
c) means for joining the receptacle and the end of the handle opposite the one end so that the receptacle is held to one side of and is spaced from the end of the handle opposite the one end to enhance the viewability of the receptacle as it is moved through the sand in a scooping motion to retrieve the shark tooth from the surface of the sand with the tool; and
a container into which shark teeth which have been retrieved from the tool for collection.
